(19) United States
(12) Patent Application Publication
(10) Pub. No.: US 2009/0118007 A1
(43) Pub. Date: May 7, 2009

(54) IMAGE DISPLAY APPARATUS AND GAME MACHINE

(75) Inventor: Eiji NAKAYA, Tatsuno (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/204,168

(22) Filed: Sep. 4, 2008

(30) Foreign Application Priority Data
Nov. 6, 2007 (JP) 2007-288147

(51) Int. Cl. A63F 13/00

(52) U.S. Cl. 463/31

(57) ABSTRACT

An image display apparatus includes an image display unit having an unshielded area and a shielded area, an instruction display section provided in the shielded area, and a display detector that detects the display on the instruction display section.

### CROSS-REFERENCE TO RELATED APPLICATION

This application claims, under 35 USC 119, priority of Japanese Application No. 2007-288147 filed Nov. 6, 2007.

### BACKGROUND

1. Technical Field

The present invention relates to an image display apparatus, and particularly to an image display apparatus suitable for use in a game machine, such as a Pachinko machine and a game console.

2. Related Art

In recent years, the mainstream of game machines, such as Pachinko machines, has been those with an image display unit, such as a liquid crystal display and a CRT display, at the central portion of a game board and a plurality of peripheral effect-producing devices formed of electrical decoration members including light emitting devices, such as LEDs (light emitting diodes) and light bulbs, electric moving parts, and audio devices in order to enhance entertainment and dramatic effects. A game machine of this type makes the game more interesting by changing the image displayed on the image display unit and operating the peripheral effect-producing devices in response to the change (see JP-A-2002-126187 and JP-A-2003-290446).

In a game machine of related art, to operate the effect-producing devices, wiring harness is used to electrically connect the effect-producing devices to a control substrate inside the game machine so as to send a control signal.

However, the internal space of a game machine such as Pachinko machines in recent years is hardly packed with a variety of electrical and mechanical elements, devices, and other components. It is therefore not easy to add an effect-producing device control substrate and route the wiring harness. Further, adding the control substrate and other modifications disadvantageously increase the cost. Moreover, to synchronize image display operation with the effect-producing devices, a separate substrate must be used to centralize timing synchronization control, disadvantageously resulting in a complicated, unfeasible structure.

### SUMMARY

An advantage of some aspects of the invention is to effectively use an image display unit to readily control the operation of a peripheral device and other components without adding a control substrate or using a harness connection unit or other components.

An image display apparatus according to an aspect of the invention includes an image display unit having an unshielded area and a shielded area, an instruction display section provided in the shielded area, and a display detector that detects optical information on the instruction display section.

According to such a configuration, the change in display on the instruction display section is detected by the display detector, and the operation of a peripheral device (target device) is controlled based on the detection result obtained from the display detector. That is, part of the image display unit can be used to control the operation of the peripheral device in the form of optical switching (in a wireless manner). Therefore, there is no need to add a control substrate or use wiring harness connection, but the peripheral device can be controlled in a simple configuration effectively using the image display unit. The invention can be widely used with a variety of apparatus with an image display unit, such a s game machines, electric apparatus, and precision instruments.

Examples of the display detector according to the aspect of the invention include a pattern recognition device and a CCD camera for recognizing the change in display on the instruction display section as the change in figure, and a light receiving element for recognizing the change in display on the instruction display section as a blinking action or the change in color.

It is preferable that the change in display on the instruction display section in the image display unit is blinking of the instruction display section, and the blinking is received as an instruction by the light receiving element. In such a case, the invention can be preferably implemented readily at a low cost in a space saving environment.

It is preferable that the image display apparatus further includes an image controller that sends image data to be displayed on the unshielded area and instruction data to be displayed on the instruction display section to the image display unit, and a device controller that controls the operation of a target device based on the detection result obtained from the display detector.

According to such a configuration, the image controller and the device controller as well as the image display unit and the display detector described above can be integrated into a single unit, which can be readily disposed at a low cost in a variety of apparatus with an image display unit, for example, game machines, electric apparatus, and precision instruments. Many advantages are thus provided, for example, contributing to integration, simplification and cost reduction of the system for controlling such apparatus.

It is preferable that the image data to be displayed on the unshielded area and the instruction data to be displayed on the instruction display section undergo an authoring process in the image controller and are converted into display data used for the whole area of the image display unit.

According to such a configuration, the image data and the instruction data are edited and mixed into integrated display data in advance, and change in the image displayed on the unshielded area of the image display unit can be readily synchronized with or related to the operation of the peripheral device. Therefore, such a configuration can be preferably used for an apparatus, such as a game machine, in which the operation of the peripheral device must be controlled as soon as in response to the change in the image displayed on the image display unit.

A game machine according to another aspect of the invention includes the image display apparatus described above. A device whose operation is controlled based on the detection result obtained from the display detector is an effect-producing device disposed in the game machine.

According to such a configuration, it is readily possible to provide game machines at a low cost, such as Pachinko machines and game consoles, in which a plurality of effect-producing devices, such as electrical decoration members including light emitting devices, such as LEDs and light bulbs, motorized role-players, and audio devices, are disposed around an image display unit, and the effect-producing devices must be operated on time in response to the change in the image displayed on the image display unit.

In Pachinko machines, game consoles and the like, it is preferable that the shielded area of the image display unit is formed to surround the unshielded area in consideration of, for example, the layout of the image display unit and a variety of effect-producing devices on a game board.

According to another aspect of the invention, a device control method includes providing an image display unit having an unshielded area and a shielded area as well as an instruction display section set in the shielded area, sending image data to be displayed on the unshielded area and instruction data to be displayed on the instruction display section to the image display unit, detecting the change in display on the instruction display section as an instruction, and controlling the operation of a target device based on the detection result.

According to such a method, the shielded area of the image display unit and the change in display in the shielded area can be effectively used to control the operation of the peripheral device. Therefore, the method can be preferably employed in an apparatus, such as a Pachinko machine and a game console, in which the operation of an effect-producing device must be controlled in a timely manner in response to the change in the image on the image display unit.

### BRIEF DESCRIPTION OF THE DRAWINGS

The invention will now be described with reference to the accompanying drawings, wherein like numbers reference like elements.

FIG. 1 is a perspective view of a Pachinko machine according to an embodiment of the invention as viewed from the front.

FIG. 2 is a simplified cross-sectional view of a play board and an image display apparatus according to the embodiment.

FIG. 3 is a front view of the game board according to the embodiment.

FIGS. 4A and 4B diagrammatically show an image controller and a device controller according to the embodiment.

FIG. 5 is a detailed diagram of the image controller according to the embodiment.

### DESCRIPTION OF EXEMPLARY EMBODIMENTS

An example of an embodiment of the invention will be described below with reference to the accompanying drawings. The example will be described with reference to a Pachinko machine as a game machine including a liquid crystal display as the image display unit and an effect-producing device (additional device enhancing visible and audible excitement) as the target device. That is, a Pachinko machine 1 of the example produces electrically decorative effects by changing the image displayed on a liquid crystal display 30 in accordance with the state of the game and controlling the operation of the effect-producing device in a timely manner. In the embodiment, the directions “front,” “rear,” “right,” “left,” “up,” and “down” correspond to those defined when a player (user) views the Pachinko machine 1 during the game.

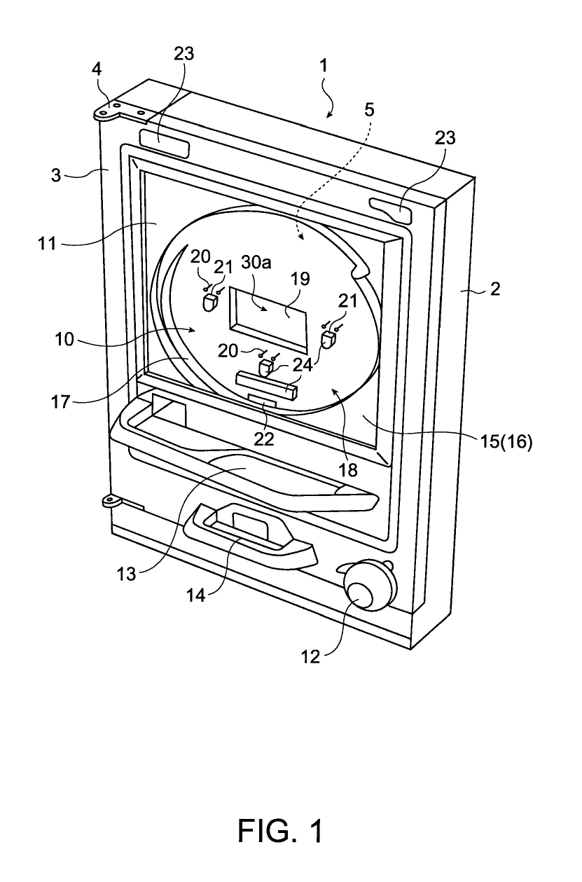

FIG. 1 is a perspective view of the Pachinko machine 1 of the example as viewed from the front. The Pachinko machine 1 includes a frame-shaped housing 2 and a game machine body 3 incorporated in the housing 2. Hinges 4 are provided on the front left side of the housing 2, and the game machine body 3 is swung forward around the hinges 4 as a hinged door. The game machine body 3 includes a game board 10 having a broad game area on the front side and light receiving elements 7 and other elements as display detectors on the rear side. A display unit 5 as an image display apparatus including a liquid crystal display 30 and other components is attached to the backside of the game board 10.

The game machine body 3 further includes a front door 11 having a light transmitting plate that covers the front side of the game board 10, a handle 12 that is provided at the lower right portion of the front side and operated to throw a game ball, an upper tray 13 that is disposed at the lower portion of the game board 10 and used to accumulate game balls, and a lower tray 14 that is disposed under the upper tray 13.

The game board 10 includes a base 15 as a fundamental member, a decorative panel 16 that is attached to the front side of the base 15, a variety of game members, which will be described later, attached to the decorative panel 16, and a game area 18 surrounded by a substantially circular guide rail 17 that guides a game ball.

The base 15 secures the game members with the decorative panel 16 therebetween, and the entire base 15 is shielded not to transmit light. An opening 19 is formed at a substantially central portion of the base 15, and the opening 19 exposes part of the liquid crystal display 30 disposed on the rear side of the base 15 as an image display area (unshielded area) 30a. The player in front of the game machine body 3 visually recognizes an image displayed on the image display area 30a through the opening 19.

The decorative panel 16 is made of a light-transmitting member substantially conformal to the base 15. The background, various characters, and other decorations are printed on the front surface of the decorative panel 16, and an opening 19 is formed at the same position as the base 15.

The game members mean all the members attached to the base 15 with the decorative panel 16 therebetween and necessary for the game. The game members correspond to, for example, the guide rail 17 that is disposed within the game area 18 and guides a game ball thrown by the handle 12 into the game area 18, a plurality of game nails 20 that change the course of the game ball, a plurality of winning holes 21, each of which causing a predetermined number of game balls to be awarded and discharged onto the lower tray 14 when a game ball enters the winning hole 21, and a out ball hole 22 that discards a game ball as a used one when the game ball enters the out ball hole 22.

The effect-producing devices mean members disposed on the front sides of the game machine body 3 and the decorative panel 16 and necessary for effect-producing operation. The effect-producing devices correspond to, for example, electrically decorative members 23 formed of light emitting devices, such as LEDs and light bulbs, and motorized role-players 24.

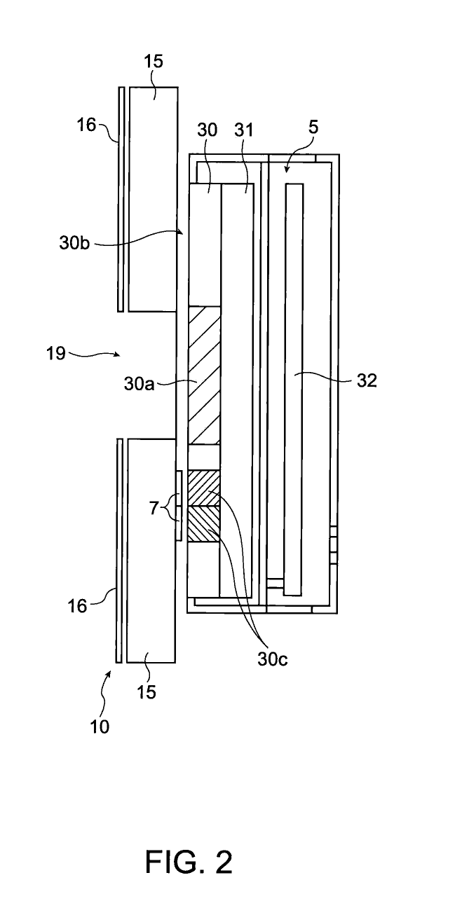

As shown in FIG. 2, the display unit 5 and other components are disposed on the backside of the game board 10. The display unit 5 includes the liquid crystal display 30, a backlight 31 attached to the backside of the liquid crystal display 30, a backlight controller (not shown) formed of a control circuit that drives and controls the backlight 31, and an image controller 40 formed of a display control circuit 32 that controls the display on the entire liquid crystal display 30. The light receiving elements 7 formed of three-terminal couplers and other elements are disposed on the backside of the base 15 in such a way that the light receiving elements 7 directly face shielded areas 30c of the liquid crystal display 30.

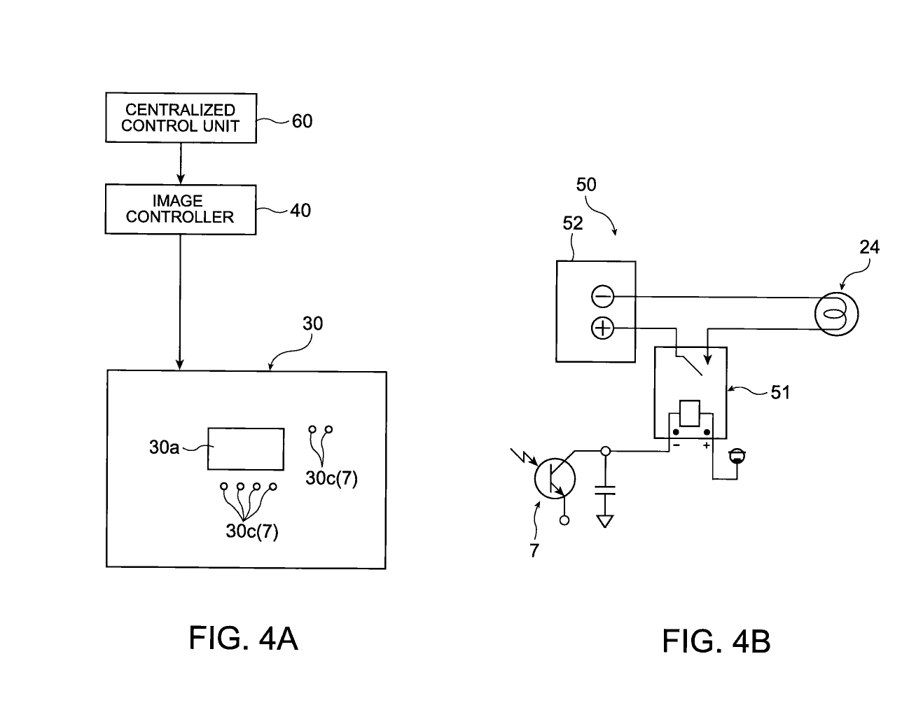

The light receiving elements 7 are respectively connected to a plurality of effect-producing devices (not shown) via a plurality of device controllers 50 (see FIG. 4B) formed of relay circuits (not shown) formed on the base 15. The operations of the effect-producing devices are controlled based on the outputs from the light receiving elements 7.

The liquid crystal display 30 includes the image display area 30a that corresponds to the opening 19 described above and a shielded area 30b that is shielded by the game board (shielding object) 10. The image display area 30a displays image data under the control of the image controller 40, and the player visually recognizes the image data through the opening 19. The shielded area 30b is not visible to the player and has a plurality of segmented instruction display sections 30c that display instruction data under the control of the image controller 40. The light receiving elements 7 respectively detect the displays on the plurality of instruction display sections 30c.

An area substantially conformal to the opening 19 is allocated to the image display area 30a and disposed in a position where the area faces the opening 19 from the rear. Images associated with the game, such as a lottery and the result of the lottery, are displayed under the control of the image controller 40 in a timely manner. The backlight 31 includes a fluorescent tube (not shown) and a reflective plate (not shown), and the backlight controller applies a voltage to the fluorescent tube to produce discharge light from the fluorescent tube. The discharge light is reflected off the reflective plate and exits toward the liquid crystal display 30.

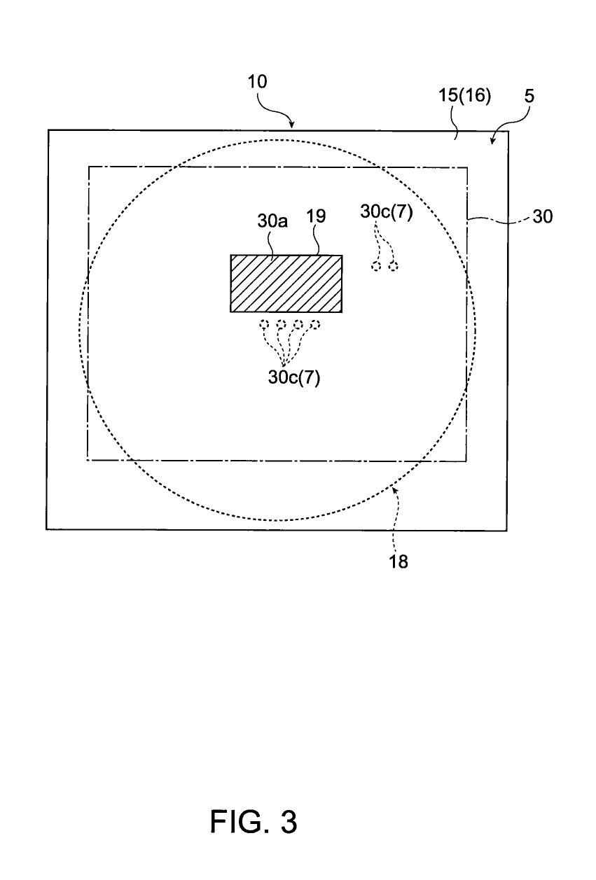

The segmented instruction display sections 30c are disposed at a plurality of locations in the shielded area 30b that respectively correspond to the effect-producing devices, as shown in FIG. 3. Each of the instruction display sections 30c performs display operation under the control of the image controller 40 in a timely manner. Specifically, RGB control in each of the instruction display sections 30c turns light emission on and off, adjusts the color, brightness, and other parameters of the emitted light, and drives the instruction display section 30c like a blinking lamp. The light receiving elements 7 are disposed in the portion of the rear side of the base 15 that is within the shielded area 30b in such a way that the light receiving elements 7 correspond to the respective instruction display sections 30c.

As shown in FIG. 4A, the image controller 40 is connected to a centralized control unit 60 that controls the entire Pachinko machine 1. The image controller 40 sends image data to be displayed on the image display area 30a and instruction data to be displayed on the instruction display sections 30c to the display unit 5 in accordance with control commands sent from the centralized control unit 60, and the liquid crystal display 30 performs display operation based on the image data and the instruction data.

Each of the device controllers 50 is a relay circuit that electrically but wirelessly conducts between the corresponding instruction display section 30c and effect-producing device and separately controls the effect-producing device. As shown in FIG. 4B, the device controller 50 includes a power supply 52, and a switch 51 connected to the light receiving element 7 that corresponds to the instruction display section 30c.

In the present example, the image data to be displayed on the image display area 30a and the instruction data to be displayed on the instruction display sections 30c (data on the color, brightness, and other parameters of emitted light) undergo an authoring process under the control of the image controller 40 to synchronize and relate the change in the image displayed on the image display area 30a with the blinking operation of the instruction display sections 30c. The image controller 40 centralizes the control associated with the above operations.

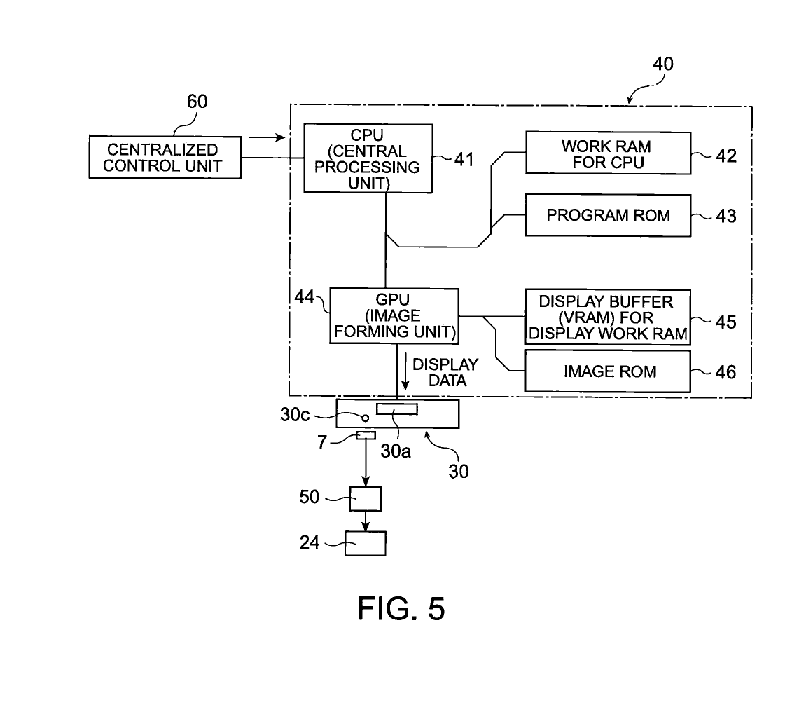

Specifically, as shown in FIG. 5, the image controller 40 includes a central processing unit (CPU) 41 that receives control commands from the centralized control unit 60 as well as a work RAM 42 for the CPU 41 and a program ROM 43. The image controller 40 further includes an image forming unit (GPU) 44, a display buffer (VRAM) 45, and an image ROM 46. The image data and the instruction data described above undergo an authoring process in the image forming unit 44, and are sent to the display unit 5 as display data for the image display apparatus. The liquid crystal display 30 then displays these data.

In this way, for example, complicated control, such as synchronizing the display of predetermined images, such as a lottery and the result of the lottery, on the image display area 30a with the turning on and blinking of a plurality of effect-producing devices, can be readily and reliably integrated, whereby the control can be simplified without degrading operation reliability.

As described above, according to the present embodiment, a plurality of instruction display sections 30c disposed on part of the liquid crystal display 30 are driven to blink, and the light receiving elements 7 detect such blinking and cause a variety of effect-producing devices disposed on the game board 10 to perform decorative and effect-producing operations. Many advantages are thus provided, including integration, simplification and cost reduction of the systems for controlling the effect-producing devices in a space saving environment.

While the present embodiment has been described with reference to the Pachinko machine 1, the invention is not limited thereto. The invention is applicable to a variety of game machines having image display apparatus, such as slot machines and game consoles, and other electric apparatus and precision instruments.

While an example of the embodiment of the invention has been described with reference to the drawings, the invention is not limited to the illustrated example. A variety of changes, of course, can be made within the scope of the technical concept set forth in the claims.

What is claimed is:

1. An image display apparatus comprising:
an image display unit having an unshielded area and a shielded area;
an instruction display section provided in the shielded area; and
a display detector that detects the display on the instruction display section.

2. The image display apparatus according to claim 1,
wherein the display detector is a light receiving element,
the display on the instruction display section is blinking thereof, and
the blinking is received as an instruction by the light receiving element.

3. The image display apparatus according to claim 1, further comprising:
an image controller that sends image data to be displayed on the unshielded area and instruction data to be displayed on the instruction display section to the image display unit; and
a device controller that controls the operation of a target device based on the detection result obtained from the display detector.

4. The image display apparatus according to claim 3,
wherein the image data to be displayed on the unshielded area and the instruction data to be displayed on the instruction display section undergo an authoring process in the image controller and are converted into display data used for the whole area of the image display unit.

5. A game machine comprising the image display apparatus according to claim 1,
wherein a device whose operation is controlled based on the detection result obtained from the display detector is an effect-producing device disposed in the game machine.

6. The game machine according to claim 5,
wherein the shielded area of the image display unit is formed to surround the unshielded area.
